(19) United States
(12) Patent Application Publication
(10) Pub. No.: US 2006/0150486 A1
(43) Pub. Date: Jul. 13, 2006

(54) Plant watering apparatus

(76) Inventor: Adedamola Adebavo Andu, Hertfordshire (GB)

Correspondence Address: Carstens & Cahoon, PO Box 802334, Dallas, TX, 75380, US

(21) Appl. No.: 10/526,329

(22) PCT Filed: Aug. 28, 2003
(86) PCT No.: PCT/GB03/03750

§ 371 Date: Sep. 28, 2005

(30) Foreign Application Priority Data
Aug. 29, 2002 (GB) 0220022.8

(51) Int. Cl. A01G 27/00

(52) U.S. Cl. 47/48.5

(57) ABSTRACT

A self-watering apparatus (1) comprising: (i) a filling tube (2) with an opening (3) at high level, said tube (2) being in fluid communication with a delivery tube (5) located at low level; (ii) a main water holding reservoir (4) adapted, in use, to receive water from said delivery tube (5), said reservoir (4) being in fluid communication with a second delivery tube (11); (iii) at least one storage chamber (10) a having a discharge orifice (13), said storage chamber (10) being adapted, in use, to receive water from the main water holding reservoir (4) by means of a second delivery tube (11) which optionally may have a capillary plug; (iv) optionally, one or more further storage chambers (16) having further discharge orifices (14) at least one of the further storage chambers (16) being in fluid communication with said chamber (10) and a pressure relieving tube (20), and (v) an outlet tube (18) with an opening (19) at high-level within said reservoir (4) through which air can be drawn into the apparatus under the control of a moisture-sensitive valve (17).

This invention relates to plant watering apparatus and in particular to improvements in the construction thereof.

A plant needs a regular supply of water for healthy growth. To maintain the plant in a healthy state, watering must be carried out with a frequency and in a quantity to maintain the plant's growing medium correctly moist.

Various devices are hitherto known and include those disclosed, for example, in WO 95/10934 and EP 0206708A2. In principle, these devices rely upon a moisture-sensitive air valve, which is in communication with the growing medium, to admit air to an otherwise sealed reservoir for controlling the dispensing of water to the medium.

Few devices have reached the market, owing to the complexity and cost of their construction.

It is an aim of the present invention to ameliorate the above disadvantages and provide a self-watering apparatus of improved construction.

Accordingly, the present invention provides a self-watering apparatus comprising a moisture-sensitive valve and a water holding body wherein said water holding body is moulded in one piece and comprises:—

(i) a filling tube with an opening at high level, said tube being in fluid communication with a delivery tube located at low level;

(ii) a main water holding reservoir adapted, in use, to receive water from said low level delivery tube, said main water holding reservoir being in fluid communication with a second delivery tube;

(iii) at least one storage chamber having a discharge orifice, said storage chamber being adapted, in use, to receive water from the main water holding reservoir by means of a second delivery tube which optionally may have a capillary plug;

(iv) optionally, one or more further storage chambers having further discharge orifices, at least one of the further storage chambers being in fluid communication with said at least one storage chamber (iii) and a pressure relieving tube, and

(v) an outlet tube with an opening at high-level within said main water holding reservoir (ii) through which air can be drawn into the apparatus under the control of said moisture-sensitive valve.

The body may be made of a plastics material and may be formed by infection moulding or blow moulding.

The pressure relieving tube connects the reservoir (ii) at a high level to the storage chamber (iii) at a low level whereby air can be purged from the reservoir (ii) during priming of the apparatus and/or when the apparatus is being re-filled.

The discharge orifice of the storage chamber (iii) is preferably located above the bottom of the chamber and the pressure-relieving tube is arranged to enter the storage chamber at a level below the discharge orifice, whereby said tube is located, in use, below the water level in the chamber.

The outlet tube may be formed integrally with the moulded water holding body.

The apparatus compensates automatically for conditions where more or less water must be supplied to a growing medium. For example, it increases the discharge of water when the growing medium is being dried by ambient heat or wind.

The flow of water from the storage chamber (iii) is such that it provides sufficient water to the growing medium without allowing excess water to leave the reservoir (ii). The discharge orifice may further comprise a bleed valve located in a wall of the storage chamber (iii).

The control of the discharge of water from the storage chamber is achieved by control of the air pressure in the reservoir chamber.

The water holding body may also contain a float member. A preferred type of float member, in use, is slidably engaged by one or more guide portions which may be integrally formed with the internal walls of the reservoir (ii). The float member serves in use to indicate the amount of water remaining in the reservoir.

A plant pot comprising a self-watering apparatus according to the present invention may be provided.

A filling funnel may be connected to the filling tube.

The plant pot may comprise an outer pot and an inner pot.

The inner pot and the outer pot may be locked together.

The invention will now be described, merely by way of example, with reference to the accompanying drawings, in which:—

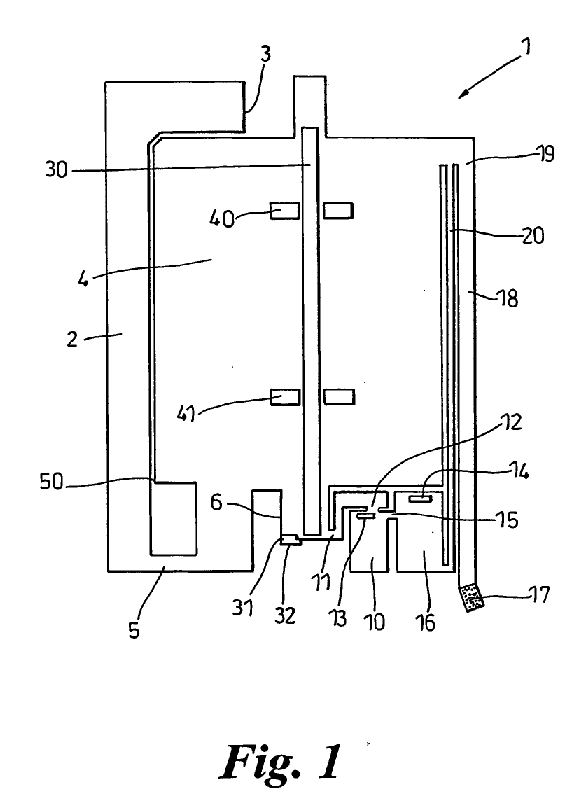

FIG. 1 is a section through a self-watering apparatus according to one embodiment of the present invention;

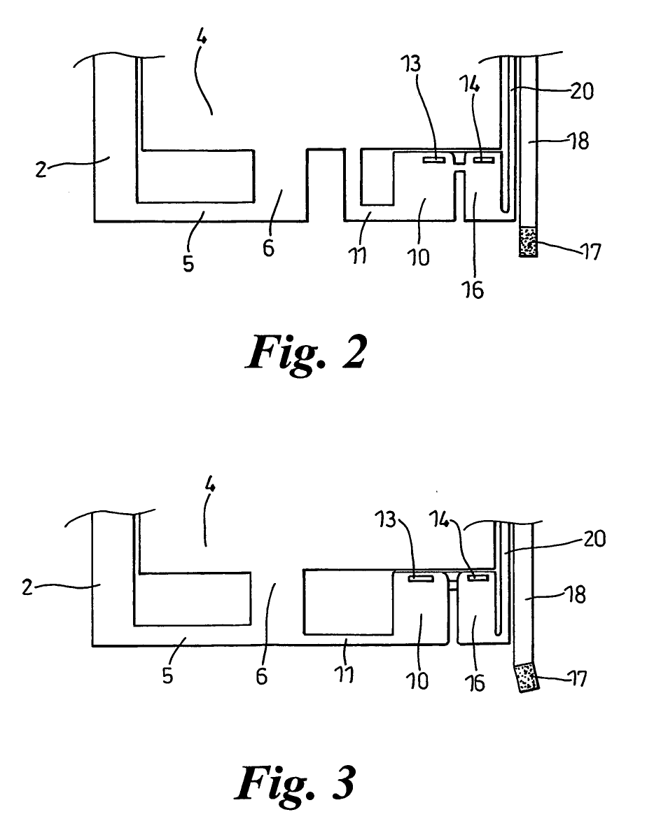

FIGS. 2 to 4 show alternative arrangements of the self-watering apparatus of FIG. 1;

FIG. 5 shows a toroidal self-watering apparatus of a second embodiment of the present invention;

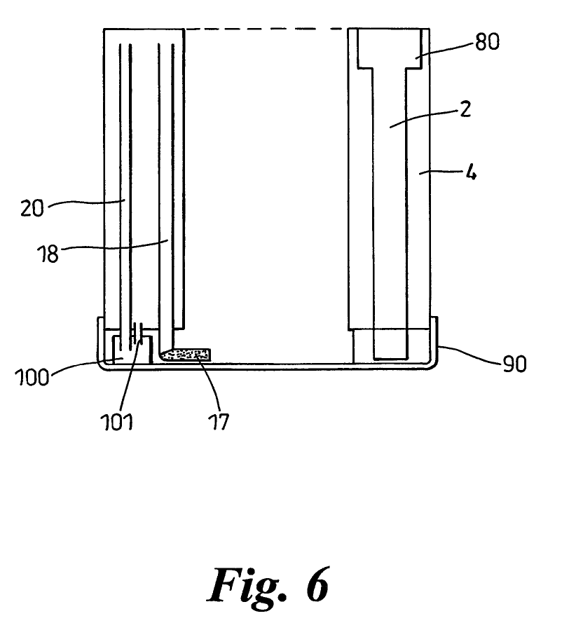

FIG. 6 shows an alternative configuration of a third embodiment of the present invention;

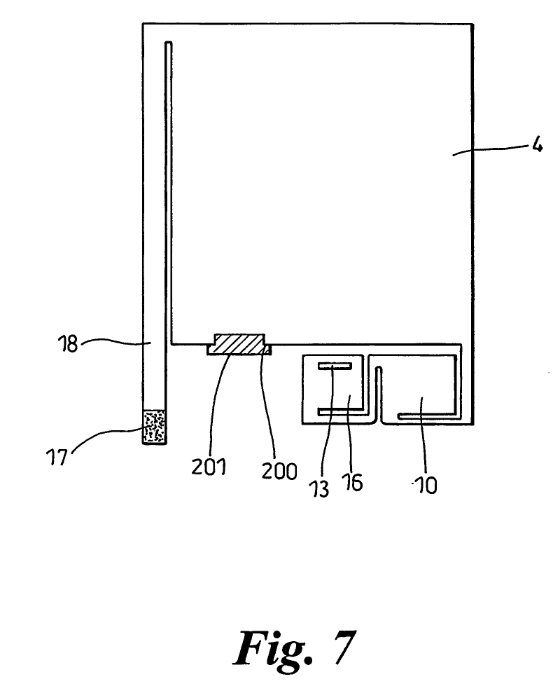

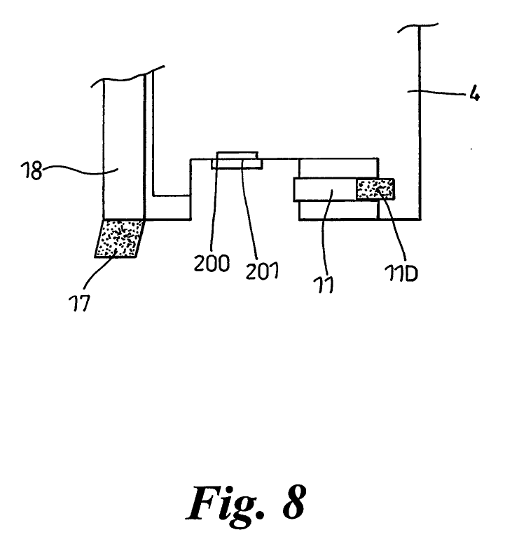

FIGS. 7 and 8 show a fourth embodiment of the present invention.

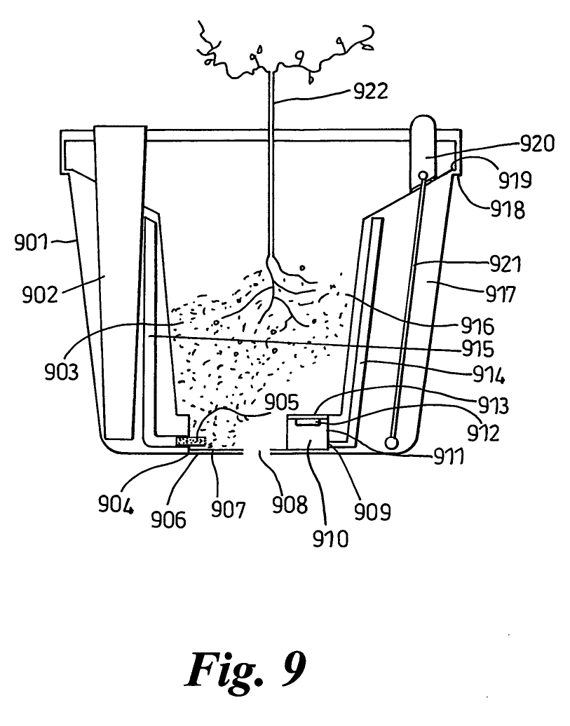

FIG. 9 shows a fifth embodiment of the present invention.

In the drawings like numerals denote like parts.

Referring to FIG. 1 a plant watering apparatus 1 is shown comprising a filling tube 2 with an opening 3 at high level. The fig tube 2 is in fluid communication with a main water holding reservoir 4 by means of a low level delivery tube 5. The main water holding reservoir includes a sump 6 which is in fluid communication with a first storage chamber 10 by means of an L-shaped delivery tube 11. The first storage chamber 10 fills with water from the delivery tube 11 through an orifice 12. Once the chamber is full water is released through a bleed valve 13. Water is also concomitantly released into a second storage chamber 16 provided with a further bleed valve through a pressure reducing valve 15.

Initially the pressure in the main water holding reservoir is equivalent to atmospheric pressure, as air is able to enter the main water holding reservoir through a moisture-sensitive valve 17, which is inserted into an outlet tube 18. The outlet tube has an opening 19 at high level into the main water holding reservoir. Additionally, the main water holding reservoir comprises a pressure relieving tube 20 which, in use, is adapted to facilitate the removal of air from the chamber 4 when it is being filled. This tube also acts to seal the chamber 4 against further ingress of air when using the water stored in the second storage chamber 16 while the apparatus is being primed.

The apparatus 1 automatically primes itself after fining by using the water that is released by the bleed valves 13,14 into a plant container to seal the moisture-sensitive valve 17. This priming action is achieved as the water level drops in the main water holding reservoir 4 by preventing the entry of air into the main water holding reservoir. This creates a reduced pressure above the level of the water in the main water holding reservoir 4. The resulting low pressure prevents any further release of water from the orifice 12 into the first storage chamber 10.

When the plant absorbs moisture from a surrounding substrate moisture is in turn absorbed via the moisture-sensitive valve 17 into the substrate. The moisture-sensitive valve 17 therefore dries out and permits air to be drawn back into the main water holding reservoir 4 which allows the ingress of water through the orifice 12 into the first and second storage chambers 10,16. Water is then discharged through the bleed valves 13,14 into the surrounding substrate. When the surrounding substrate is saturated with water the moisture-sensitive valve 17 also becomes saturated with water. This prevents the ingress of air into the water holding reservoir 4 causing reduced atmospheric pressure above the level of water in the man reservoir and prevents the flow of water through the orifice into the storage chambers 10,16.

When the apparatus 1 is re-filled the pressure in the main water holding reservoir 4 increases as water enters the reservoir 4. The increase in air pressure forces air into the pressure relieving tube 20 and into the second storage chamber 16 where air is forced out of the bleed valve 14. When the second storage chamber 16 is full the main water holding reservoir 4 is sealed against further ingress of air.

The sump 6 serves to deliver water into the L-shaped delivery tube 11 the sump 6 may also provide a means to receive a float member 30 when the main water reservoir 4 is empty. The float 30 is inserted through a hole 31 located at the base of the sump 6 which is then sealed by means of a resilient plug 32. The float 30 is slidably engaged by central guides 40,41 which are integrally moulded with the sides of the water chamber. The guides 40,41 also serve to prevent the sides of the plant watering apparatus collapsing under reduced (negative) pressure.

When the air pressure is reduced in the main water holding reservoir 4 the water level in the filling tube 2 drops substantially below the base 50 of the main water holding reservoir 4. In order to prevent air from entering the main water holding reservoir 4 the low level tube 5 needs to be situated at the lowest possible point in the apparatus 1.

Referring to FIG. 2 the plant watering apparatus 1 is shown having an alternative arrangement for the delivery of water from the main water holding reservoir 4 into the first and second storage chambers. The delivery tube serves to deliver water from the main water holding reservoir 4 into the first and second storage chambers 10,16. The sump 6 provides a delivery means from the filling tube 2 such that water can enter the main water holding reservoir 4.

Referring to FIG. 3 a further alternative arrangement of the present invention is shown. The delivery tube 11 is in direct communication with the sump 6.

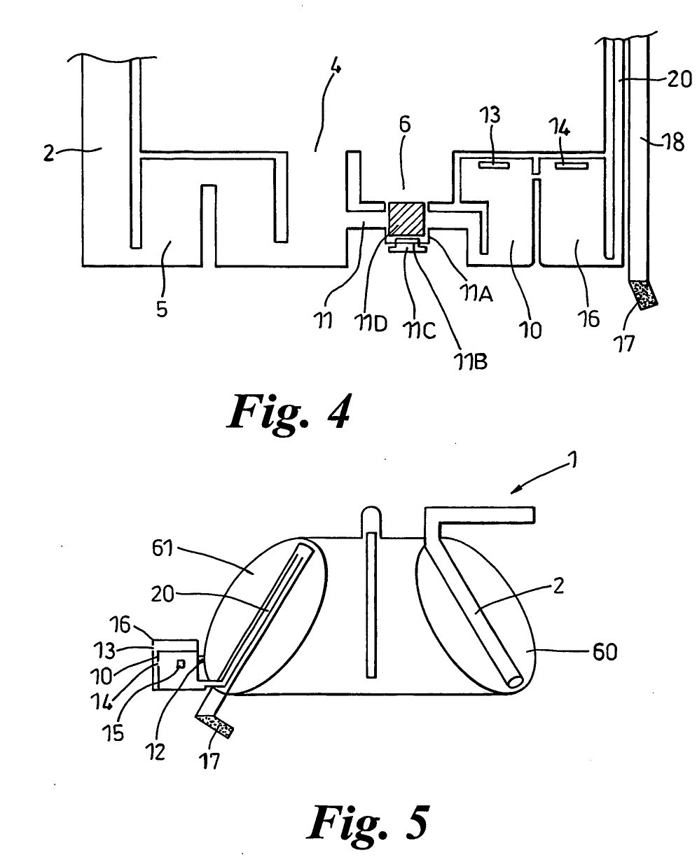

Referring to FIG. 4 a vibration-resistant plant watering apparatus is shown. The delivery tube 5 is substantially S-shaped in order to prevent the ingress of air into the main water holding reservoir 4. The low level delivery tube 11 has as part of its construction a duct 11A which is open to sump 6. A capillary plug 11D is inserted through a hole 11B into the duct to retard the flow of water in the low level delivery tube 11 so as to prevent the ingress of air into the system. Hole 11B is sealed with a plug 11C.

Referring to FIG. 5 there is shown an alternative arrangement of a watering apparatus in accordance with the present invention. The apparatus 1 is substantially toroidal in configuration having two water holding chambers 60,61 diametrically opposed with respect to each other. The filling tube 2 is in fluid communication at low level with both water holding chambers. When the water holding chambers 60,61 are filled the storage chambers 10,16 are concomitantly filled with water through an orifice 12. The two storage chambers are in fluid communication with each other via a connecting duct 15. The storage chambers are provided with bleed valves 13,14 so that water may be discharged into the surrounding plant medium.

The second storage chamber 16 is in, communication with a pressure-relieving tube 20.

Referring to FIG. 6 another embodiment of the present invention is shown. The plant watering apparatus is configured as a plant pot. The walls of the pot provide a continuous, toroidal, reservoir 4. A filling funnel 80 is connected to a filling tube 2 to allow the water reservoir 4 to be filled. The apparatus 1 also comprises a lid 90 of complementary configuration to the pot in order to seal the system against the ingress of air. The lid forms, when fitted to the base of the apparatus, an “open” sump 100 in which water can be released using a connecting tube 101. This sump 100 serves as a storage chamber. The storage chamber is in communication with a pressure-relieving tube 20.

Referring to FIG. 7 a further embodiment of an anti-vibration plant watering apparatus is shown. The apparatus is substantially rectangular in shape. The apparatus comprises an opening 200 to fill the apparatus which is sealed by a resilient plug 201 of complementary configuration. The opening is located on the base of the apparatus. Once the chamber has been filled the apparatus is then inverted and water is delivered to the first and second storage chambers 10,16. Water is discharged through the bleed valve 13 into the growing medium.

Referring to FIG. 8 a further embodiment of an anti-vibration plant watering plant apparatus is shown.

A delivery tube 11 has inserted in it a capillary plug 11D. Plug 11D is arranged with respect to chamber 4 such that the ingress of air into the system is prevented.

The embodiment shown in FIG. 9 consists of two separate parts, namely outer pot 901 and inner pot 916. Inner pot 916 comprises of a filler tube 902, a control tube 915, a breather tube 914 and an indicator viewer 920, all of which are situated outside the inner pot. The inner pot also consists of a storage chamber 910 and cap 913, which are situated inside the inner pot. Holes 909 and 911 are open only into storage chamber 910 on the inner pot. Tube 914 forms a tight seal into hole 909 and extends to the top part of the inner pot. A hole 904 at the bottom of the inner pot is open into the inside of the inner pot. Tube 915 with a capillary plug 905 forms a tight seal into hole 904. A hole 908 is placed at the bottom of both inner pot 916 and outer pot 901. The inner pot 916 is placed inside outer pot 901 and a tight seal is formed between surface 918 of outer pot 901 and surface 919 of inner pot 916, to keep both pots locked together and to form a water storage chamber 917 between the inner pot 916 and outer pot 901. The bottom surface 907 of inner pot 916 and the inner part of bottom face 906 of the outer pot 901 are also tightly joined together. The two pots can either be locked together (e.g. by means of screws) or welded together.

When in use, water is poured into filler tube 902 to fill chamber 917. Air escapes from breather tube 914 into inner pot 916, via slit 912. Water from filling chamber 917 also enters storage chamber 910 via hole 911 and overflows, via slit 912, into the inner part of inner pot 916 to moisten compost 903. The filling chamber 917 also lifts float 912 into viewer 920, to show whether the chamber is full or empty.

After filling, the water released via hole 911 into the inner pot also moistens the capillary plug 905 in tube 915. As a result, the intake of air from tube 915 into the top part of chamber 917 is blocked, thus causing the formation of a vacuum in chamber 917 which results in the stop of flow from hole 911. Simultaneously, water stored in storage chamber 910 is pulled up breather tube 914 to seal chamber 917.

Capillary plug 905 is in contact with compost 903 and as the plant 922 uses the moisture in compost 903, the compost starts to dry out, which also dries out capillary plug 905, When capillary plug 905 is dry, air in the inner pot 916 enters chamber 917 via tube 915, to break the vacuum in chamber 917. Water is released into storage chamber 910 via hole 911. The cycle repeats until all the water in the chamber is used up by plant 922.

1-10. (canceled)

11. A self-watering apparatus comprising a moisture-sensitive valve and a water holding further comprises:
(i) a filling tube with an opening at high level, said tube being in fluid communication with a delivery tube located at low level;
(ii) a main water holding reservoir adapted, in use, to receive water from said low level delivery tube, said main water holding reservoir being in fluid communication with a second delivery tube;
(iii) at least one storage chamber having a discharge orifice, said storage chamber being adapted, in use, to receive water from the main water holding reservoir by means of a second delivery tube;
(iv) one or more further storage chambers having further discharge orifices, at least one of the further storage chambers being in fluid communication with said at least one storage chamber (iii) and a pressure relieving tube, and
(v) an outlet tube with an opening at high-level within said main water holding reservoir (ii) through which air can be drawn into the apparatus under the control of said moisture-sensitive valve.

12. Apparatus according to claim 1 wherein at least one storage chamber has a capillary plug.

13. Apparatus according to claim 1, in which the pressure relieving tube connects the reservoir (ii) at a high level to the storage chamber (iii) at a low level.

14. Apparatus according to claim 1, in which the discharge orifice of the storage chamber (iii) is located above the bottom of said chamber and the pressure relieving tube is arranged to enter said chamber at a level below the discharge orifice, whereby said tube is located, in use, below the water level in said chamber.

15. Apparatus according to claim 1, in which the outlet tube (v) is formed integrally with said water holding body.

16. Apparatus according to claim 1, in which the discharge orifice further comprises a bleed valve located in a wall of the storage chamber (iii).

17. Apparatus according to claim 1, in which the water holding body further comprises a float member.

18. Apparatus according to claim 7, in which the float member is, in use, slidably engaged by one or more guide portions integrally formed with the internal walls of the reservoir (ii).

19. A plant pot comprising a self-watering apparatus according to claim 1.

20. A plant pot according to claim 9 wherein the at least one storage chamber comprises a sump consisting of a lid fitted to the base of the apparatus.

21. A plant pot according to claim 9 wherein the walls of the plant pot provide a continuous, toroidal, reservoir.

22. A plant pot according to claim 9 wherein the plant pot comprises an outer pot and an inner pot.

23. A plant pot according to claim 12 wherein the inner pot comprises a storage chamber and a cap.

24. A plant pot according to claim 12 wherein the inner pot comprises at least one from the group of:
i) a filler tube;
ii) a control tube;
iii) a breather tube; and
iv) an indicator viewer.

25. A plant pot according to claim 14 wherein at least one from the group of:
i) a filler tube;
ii) a control tube:
iii) a breather tube; and
iv) an indicator viewer are provided outside the inner pot.

26. A plant pot according to claim 14 further comprising a hole in a storage chamber of the inner pot, wherein the breather tube forms a seal with the hole and the breather tube extends to the top part of the inner pot.

27. A plant pot according to claim 14 further comprising a hole at the bottom of the inner pot, wherein the control tube with a capillary plug forms a seal into the hole.

28. A plant pot according to claim 12 wherein a water storage chamber is formed between the inner pot and the outer pot.

29. A plant pot comprising a moisture-sensitive valve and a water holding body wherein said water holding body is moulded in one piece and comprises:
(i) a filling tube with an opening at high level, said tube being in fluid communication with a delivery tube located at low level;
(ii) a maid water holding reservoir adapted, in use, to receive water from said low level delivery tube, said main water holding reservoir being in fluid communication with a second delivery tube;
(iii) at least one storage chamber having a discharge orifice, said storage chamber being adapted, in use, to receive water from the main water holding reservoir by means of a second delivery tube;
(iv) one or more further storage chambers having further discharge orifices, at least one of the further storage chambers being in fluid communication with said at least one storage chamber (iii) and a pressure relieving tube, and
(v) an outlet tube with an opening at high-level within said main water holding reservoir (ii) through which air can be drawn into the apparatus under the control of said moisture-sensitive valve.

30. A self-watering apparatus comprising a moisture-sensitive valve and a water holding body wherein said water holding body is moulded in one piece and comprises:
(i) a filling tube with an opening at high level, said tube being in fluid communication with a delivery tube located at low level;
(ii) a main water holding reservoir adapted, in use, to receive water from said low level delivery tube, said main water holding reservoir being in fluid communication with a second delivery tube;
(iii) at least one storage chamber having a discharge orifice, said storage chamber being adapted, in use, to receive water from the main water holding reservoir by means of a second delivery tube;
(iv) one or more further storage chambers having further discharge orifices, at least one of the further storage chambers being in fluid communication with said at least one storage chamber (iii) and a pressure relieving tube, and
(v) an outlet tube with an opening at high-level within said main water holding reservoir (ii) through which air can be drawn into the apparatus under the control of said moisture-sensitive valve.
